(19) United States
(12) Patent Application Publication
(10) Pub. No.: US 2009/0322301 A1
(43) Pub. Date: Dec. 31, 2009

(54) Control circuit for improving efficiency of lower load of power supply device and method thereof

(75) Inventor: Chin-Yun Chang, Taoyuan County (TW)

Correspondence Address: BACON & THOMAS, PLLC, 625 SLATERS LANE, FOURTH FLOOR, ALEXANDRIA, VA, 22314-1176, US

(73) Assignee: ENERMAX TECHNOLOGY CORPORATION, Taoyuan County (TW)

(21) Appl. No.: 12/213,889

(22) Filed: Jun. 26, 2008

(51) Int. Cl. G05F 1/00

(52) U.S. Cl. 323/284

(57) ABSTRACT

In a control circuit and a method for improving the efficiency of a lower load of a power supply device, the power supply device includes power stages, for inputting an input power to the power supply device and producing an output power to drive a load; a control circuit electrically coupled to the power stages for detecting a drive load and issuing a control signal for turning on/off one of the power stages. The control method includes: setting a predetermined output load value by a control circuit; detecting a total output load of the power stages by the control circuit; comparing the total output load with the predetermined output load value; and turning on/off one of the power stages by the control circuit according to a comparison result. The invention reduces the loss of power stages at a low load to enhance the power saving effect and the economic efficiency.

### BACKGROUND OF THE INVENTION

1. Field of the Invention

The present invention relates to a technology for improving the efficiency of a power supply device, and more particularly to a control circuit and a control method of a power supply device for reducing the basic loss at a lower output load as well as improving the efficiency of a lower output load to achieve a power saving effect.

2. Description of the Related Art

As computers or other electronic devices generally come with a power supply device for converting a 110V or 220V AC utility power into a 3.3V, 5V or 12V DC power required by a hardware device such as a motherboard, a hard disk or an optical disk, the power supply device 90 as shown in FIG. 1 comprises two power stages 91, 92, each having a pulse width modulation (PWM), and the two power stages 91, 92 are provided for converting the amplitude of an input power into a pulse with a specific width to achieve the effect of outputting a signal with an amplitude change of an analog voltage, so that the analog voltage and current can be controlled directly for the operation of the hardware devices. In FIG. 1, an external power is inputted into the power supply device 90. After the power is divided and modulated by the two power stages 91, 92, an output power is integrated and outputted to drive a load. As the load varies during the operation of the power supply device 90, the power supply device 90 can use the two power stages 91, 92 to achieve applications with a wider range of loads, but the overall performance will be lower than a single power stage when the power supply device 90 outputs a lower load. As a result, the efficiency is low, the power loss is high, and the heat dissipating effect is poor.

As the energy shortage issue becomes increasingly serious and a large number of personal computers are used in these days (according to the statistics provided by the Forrester Research, the total number of personal computers used as of the end of 2008 is up to one billion, the whole world can save tens of billions of kWh power per year if we can improve the operating efficiency of the power supply devices. Therefore, finding a way of enhancing the operating efficiency of a power supply device demands immediate attentions, breakthroughs, and feasible solutions.

In view of the shortcomings of the conventional power supply device with a poor operating efficiency at a lower output load and a poor structural design, the inventor of the present invention based on years of experience in the related industry to conduct extensive researches and experiments, and finally developed a more efficient and power-saving control circuit for improving the efficiency of a lower load of a power supply device and a control method to overcome the aforementioned shortcomings and promote the development of the industry.

### SUMMARY OF THE INVENTION

The primary objective of the present invention is to overcome the shortcomings of the prior art by providing a control circuit and a control method for improving the efficiency of a lower load of a power supply device, wherein the control circuit is added to two power stages, such that if a total output load is smaller than a predetermined load, then the control circuit will issue a control signal to turn off one of the power stage, and if the total output load is greater than the predetermined load, the closed power stage will be turned on again. With the control circuit, the invention can reduce the basic loss of the power stage at a lower output load to achieve a power saving effect and improve the economic efficiency.

The control circuit of the invention is applied to a power supply device of a switching or interleaved converter to achieve the foregoing objectives and effects, and the power supply device comprises two power stages, a pulse width modulator installed on the power stages, and an input power supply, such that after a power is inputted to the power supply device, an output power is integrated and outputted to drive a load; a control circuit, electrically coupled to the power supply device, for detecting a driving load of the power supply device and issuing a control signal for turning on or off one of the power stages.

The technical measures of the invention includes: an input stage, for inputting an AC power; two power stages, coupled to the input stage, and including a first power stage, a second power stage, a first control switch, a second control switch and a pulse width modulation (PWM), and the first power stage and the second power stage are coupled to the input stage and the first control switch respectively, and the second control switch is coupled to the first power stage and the second power stage respectively, and the pulse width modulation (PWM) is coupled to the first control switch and the second control switch; a control circuit, coupled to the first control switch and the second control switch, wherein the control circuit is coupled to the first power stage and the second power stage for detecting an output load of the first/second power stage.

The control method of the invention comprises the steps of:

(1) using a control circuit to set a predetermined output load value; (2) using the control circuit to detect a total output load of power stages; (3) comparing the total output load with the predetermined output load value; and (4) using the control circuit to turn on or off one of the power stages according to a comparison result.

To make it easier for our examiner to understand the objects, shape, characteristics and performance of the present invention, we used preferred embodiments accompanied with related drawings for the detailed description of the invention as follows.

### BRIEF DESCRIPTION OF THE DRAWINGS

FIG. 1 is a schematic circuit block diagram of a power supply circuit of a power supply device according to a prior art;

FIG. 2 is a schematic circuit block diagram of a main structure according to the present invention;

FIG. 3 is a schematic view of a circuit operating flow according to the present invention;

FIG. 4 is a flow chart of a control method according to the present invention; and

Attachment shows an efficiency comparison table of two power stages when one of the power stages is turned off.

### DETAILED DESCRIPTION OF THE PREFERRED EMBODIMENTS

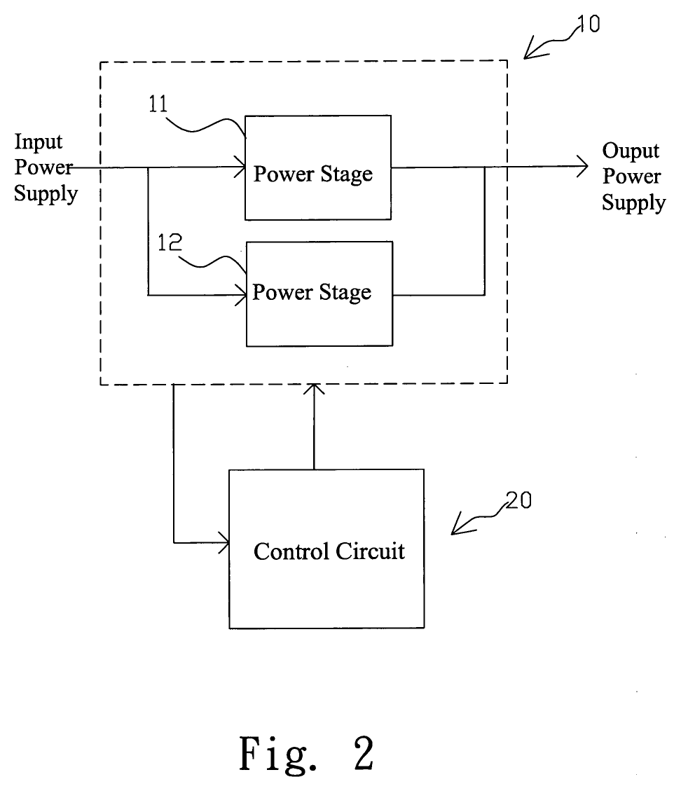

Referring to FIG. 2 for a control circuit for improving the efficiency of a lower load of a power supply device in accordance with the present invention, the control circuit is applied to power supply device of a switching or interleaved converter. The control circuit comprises a power supply device 10 and a control circuit 20. The power supply device 10 further includes two power stages 11, 12, and the circuits of the power stage 11, 12 are provided for converting the amplitude of an input power into a pulse with a specific width to output a signal with an amplitude change of an analog voltage, so as to achieve the effect of controlling the analog voltage and current directly for the operation. After an input power is inputted to the power supply device 10 and divided and modulated by the power stages 11, 12, an output power is integrated and outputted to drive a load.

The control circuit 20 is electrically coupled to the power supply device 10 for detecting a total output load of the power supply device 10. If the total output load of the power supply device 10 is smaller than a predetermined load, then a control signal will be issued to turn off one of the power stages 11, 12. If the total output load of the power supply device 10 is greater than the predetermined load, then the closed power stage 11, 12 will be turned on again, and the detection functions and the ON and OFF operations are maintained all the time to achieve the power-saving control effect.

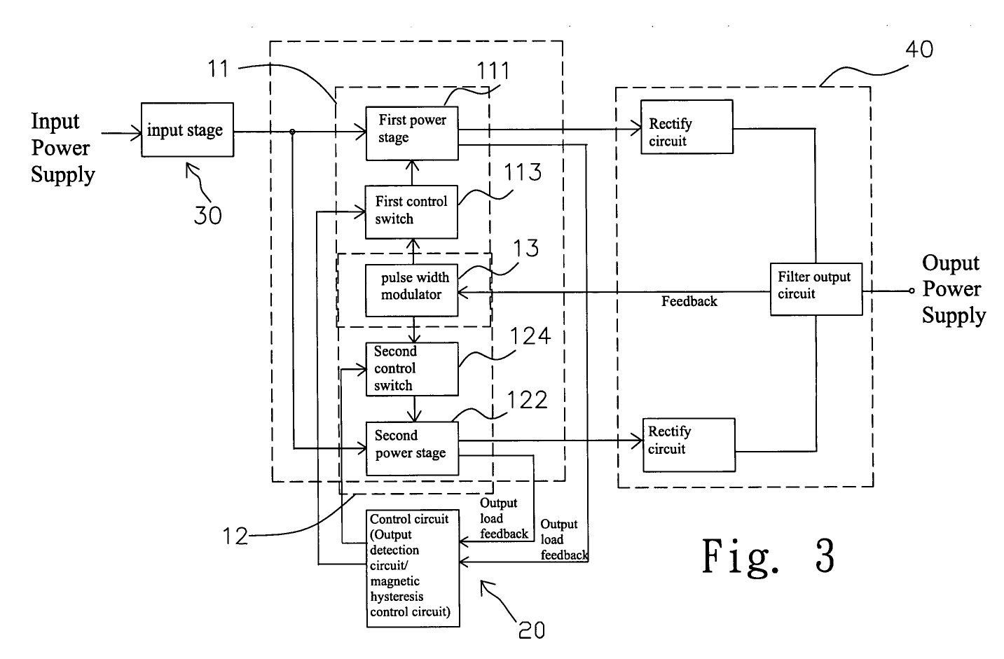

Referring to FIG. 3 for a schematic view of an operating flow of a control circuit for improving the efficiency of a lower load of a power supply device according to the present invention, the circuit comprises an input stage 30 for inputting an AC power; two power stages 11, 12, including a first power stage 111, a second power stage 122, a first control switch 113, a second control switch 124 and a pulse width modulator 13, and the first power stage 111 and the second power stage 122 are coupled to the input stage 30, and the first control switch 113 (EN/Disable Controller) and the second control switch 124 (EN/Disable Controller) are coupled to the first power stage 111 and the second power stage 122 respectively, and the pulse width modulation (PWM) 13 is coupled to the first control switch 113 and the second control switch 124, and the drive circuit is used for controlling the electric connection of the first control switch 113 and the second control switch 124. The first power stage 11 is operated by the pulse width modulation (PWM) 13, the first control switch 113, and the first power stage 111, and the second power stage 12 is operated by the pulse width modulation (PWM) 13, the second control switch 124 and the second power stage 122 (as shown in FIG. 2), and the first power stage 111 and the second power stage 122 are coupled to a rectify/filter circuit 40, and the rectify/filter circuit 40 includes a rectify circuit and a filter output circuit for converting an input AC power into an output DC power, and the filter output circuit feeds back the converted power to the pulse width modulation (PWM) 13.

The control circuit 20 further comprises an output detection circuit and a magnetic hysteresis control circuit, and the control circuit 20 is coupled to the first control switch 113 and the second control switch 124, and the first power stage 111 and the second power stage 122 feed back an output load to the control circuit 20, so that the output detection circuit detects the output load of the first power stage 111 and the second power stage 122. If the total load is smaller than a predetermined load, then the control circuit 20 will issue a control signal to turn off one of the power stages 11, 12. If the output load is greater than the predetermined load, then the closed power stage 11, 12 will be turned on again. For instance, if the total load is set to 0˜40% of the output load, one of the power stages 11, 12 will be turned off. If the total load exceeds 40%, then the closed power stage 11, 12 will be turned on again. If the total load drops below 35% again, then one of the power stages 11, 12 will be turned off again. Such arrangement of using the control circuit 20 to maintain the detection of the output load and the operation of turning off/off the power stages 11, 12, so as to achieve the effects of reducing the basic loss of the two power stages at a low load and controlling the power saving effect all the time. Since one of the power stages is turned off at a low load, the power saving efficiency can be improved by 2.2% (as shown in the attachment), and thus the overall power saving effect is very significant for the huge number of personal computers, which constitutes a substantial contribution to the environmental protection of the earth and the utility of energies.

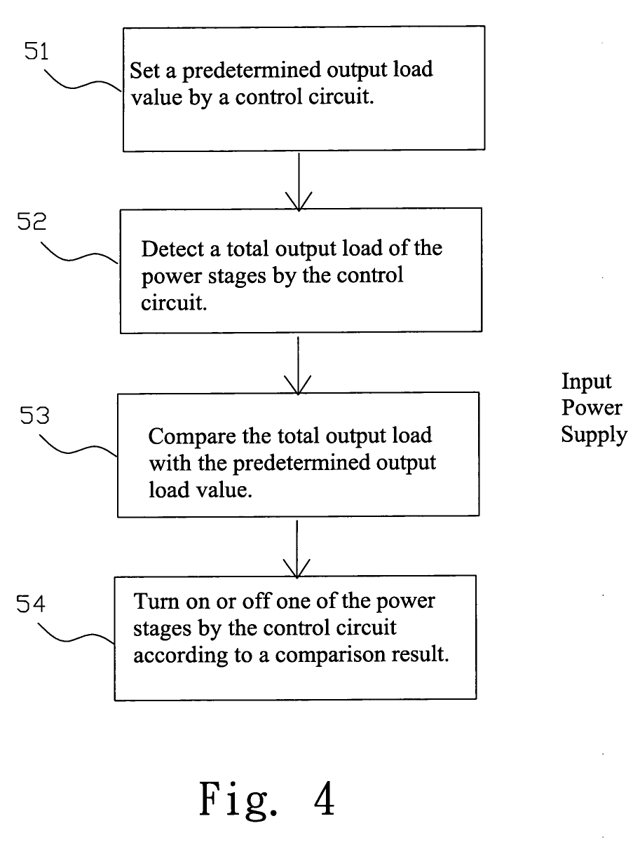

Referring to FIG. 4 for the foregoing structure of a control circuit for improving the efficiency of a lower load of a power supply device, a control method comprises the steps of: (1) setting a predetermined output load value by a control circuit (Step 51), wherein the predetermined output load value is a total output load of the power stages 11, 12; (2) detecting a total output load of the power stages 11, 12 by the control circuit (Step 52); in other words, the control circuit detects the total output load of the power stage 11, 12; (3) comparing the total output load with the predetermined output load value (Step 53), wherein the detected total output load is smaller or greater than the predetermined output load value; and (4) turning on or off one of the power stages by the control circuit according to a comparison result (Step 54). In other words, if the detected total output load is smaller than the predetermined output load value, the control circuit 20 will turn off one of the power stages 11, 12, and if the detected output load is greater than the predetermined output load value, the control circuit 20 will turn on the closed power stage 11, 12.

The main feature of the present invention is the installation of the control circuit provided for detecting and turning ON/OFF the power stages to achieve the overall power saving effect. Similarly, the same principle in accordance with the aforementioned embodiments can be applied for detecting and controlling the ON/OFF of a plurality of power stages, and the pulse width modulation (PWM) can be implemented by a power factor correction (PFC) to achieve the equivalent power saving effect.

In summation of the above description, the present invention herein enhances the performance of the conventional structures and further complies with the requirements of patent application and is thus duly filed for the patent application.

While the invention has been described by means of specific embodiments, numerous modifications and variations could be made thereto by those skilled in the art without departing from the scope and spirit of the invention set forth in the claims.

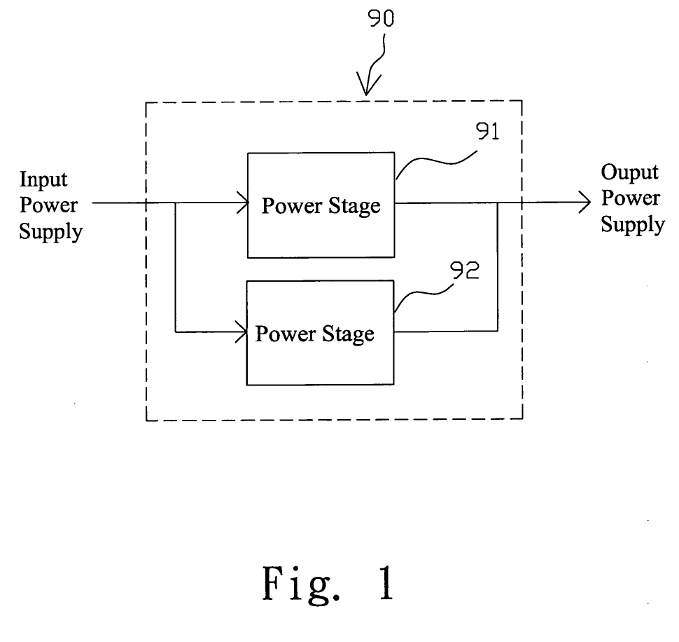

Table of Comparing the Efficiency of a Dual
Power Module When One Module is Turned Off

| | | Efficiency of One |
|---|---|---|
| | Efficiency of a | Module When 0~40% |
| Load (%) | Dual Power Module | Power Is Turned Off |
| 20 | 83.5 | 85.7 |
| 50 | 89.1 | 89.1 |
| 100 | 85.3 | 85.3 |

| | | |
|---|---|---|
| Input Power Supply | Power Stage | Ouput Power Supply |
| | Power Stage | |
| FIG. 1 | | |
| Input Power Supply | Power Stage | Ouput Power Supply |
| | Power Stage | |
| | Control Circuit | |

FIG. 2
Input Power Supply
First power stage 111
Second power stage 122
First control switch 113
Second control switch 124
pulse width modulator 13
Control circuit (Output detection circuit/magnetic hysteresis control
circuit) 20
input stage 30
Output load feedback
Output load feedback
Rectify circuit
Feedback
Rectify circuit
Filter output circuit
Ouput Power Supply
FIG. 3

| | |
|---|---|
| 51 | Set a predetermined output load value by a control circuit. |
| 52 | Detect a total output load of the power stages by the control circuit. |
| 53 | Compare the total output load with the predetermined output load |
| | value. |
| 54 | Turn on or off one of the power stages by the control circuit accord- |
| | ing to a comparison result. |

FIG 4.

What is claimed is:

1. A control circuit for improving the efficiency of a lower load of a power supply device, comprising:
at least two power stages, installed on said power supply device, for integrating an output power to drive a load after an input power inputs said power stages;
a control circuit, electrically coupled to the power stages, for detecting the condition of a driven load of said power supply device and issuing a control signal to turn on or off one of said power stages.

2. The control circuit for improving the efficiency of a lower load of a power supply device according to claim 1, wherein said power supply device is a switching power supply device or an interleaved power supply device.

3. The control circuit for improving the efficiency of a lower load of a power supply device according to claim 1, wherein said power stage includes a pulse width modulator installed thereon.

4. The control circuit for improving the efficiency of a lower load of a power supply device according to claim 1, wherein said power stage includes a power factor correction circuit installed thereon.

5. The control circuit for improving the efficiency of a lower load of a power supply device according to claim 1, wherein said control circuit includes an output detection circuit and a magnetic hysteresis control circuit.

6. A control circuit for improving the efficiency of a lower load of a power supply device, comprising:
an input stage, for inputting an AC power;
at least two power stages, coupled to said input stage, and including a first power stage, a second power stage, a first control switch, a second control switch and a pulse width modulator, and said first power stage and said second power stage being coupled to said input stage and said first control switch respectively, and said second control switch being coupled to said first power stage and said second power stage respectively, and said pulse width modulator being coupled to said first control switch and said second control switch;
a control circuit, coupled to said first control switch and said second control switch for detecting an output load of said first power stage and said second power stage;
a rectify/filter circuit, having a rectify circuit and a filter output circuit, and coupled to said first power stage and second power stage, for converting an input AC power into an output DC voltage, and said rectify/filter output circuit feeding back said power stages.

7. The control circuit for improving the efficiency of a lower load of a power supply device according to claim 6, wherein said power stage is operated by said first control switch, said first power stage and said pulse width modulator.

8. The control circuit for improving the efficiency of a lower load of a power supply device according to claim 6, wherein said power stage is operated by said second control switch, said second power stage and said pulse width modulator.

9. The control circuit for improving the efficiency of a lower load of a power supply device according to claim 6, wherein said power stage is operated by said first control switch, said first power stage and said power factor correction circuit.

10. The control circuit for improving the efficiency of a lower load of a power supply device according to claim 6, wherein said power stage is operated by said second control switch, said second power stage and said power factor correction circuit.

11. The control circuit for improving the efficiency of a lower load of a power supply device according to claim 6, wherein said control circuit includes an output detection circuit and a magnetic hysteresis control circuit.

12. A control method for improving the efficiency of a lower load of a power supply device, comprising a power supply device and a control circuit, and said power supply device comprising a plurality of power stages, and said control method comprising the steps of:
(1) setting a predetermined output load value by a control circuit;
(2) detecting a total output load of said power stages by said control circuit;
(3) comparing said total output load with said predetermined output load value;
(4) turning on or off one of said power stages by said control circuit according to a comparison result.

13. The control method for improving the efficiency of a lower load of a power supply device according to claim 12, wherein said power supply device is a switching power supply device or an interleaved power supply device.

14. The control method for improving the efficiency of a lower load of a power supply device according to claim 12, wherein said step (2) detects an output load of said power stage by an output detection circuit, and the total output is the total output load of said power stages.

15. The control method for improving the efficiency of a lower load of a power supply device according to claim 12, wherein said step (4) turns off one of said power stages by said control circuit if said detected total output load is smaller than said predetermined output load value.

16. The control method for improving the efficiency of a lower load of a power supply device according to claim 15, wherein said control circuit turns on said closed power stage if said detected total output load is greater than said predetermined output load value.
